(19) United States
(12) Patent Application Publication
(10) Pub. No.: US 2009/0070420 A1
(43) Pub. Date: Mar. 12, 2009

(54) SYSTEM AND METHOD FOR PROCESSING DATA SIGNALS

(76) Inventor: Schuyler Quackenbush, Westfield, NJ (US)

Correspondence Address: MALDJIAN & FALLON LLC, 365 BROAD ST. , 3RD FLOOR, RED BANK, NJ, 07701, US

(21) Appl. No.: 12/233,416

(22) Filed: Sep. 18, 2008

Related U.S. Application Data
(63) Continuation-in-part of application No. 11/740,794, filed on Apr. 26, 2007.
(60) Provisional application No. 60/973,376, filed on Sep. 18, 2007.
(60) Provisional application No. 60/796,396, filed on May 1, 2006.

(51) Int. Cl. G06F 15/16

(52) U.S. Cl. 709/204

(57) ABSTRACT

Embodiments of the present invention generally relate to a system and method for listeners, or “virtual fans,” to exist in a monitor mode during a real-time multimedia collaboration via a global computer network. In one embodiment, a system for processing data signals via a communication network comprises a first data signal received from a first client, a second data signal received from a second client, a mixer for mixing the first and second data signals, a first unique data mix, for the first client, generated by the mixer, a second unique data mix, for the second client, generated by the mixer, and a third unique data mix, for a fan room, generated by the mixer.

### CROSS-REFERENCE TO RELATED APPLICATIONS

This application is a continuation-in-part of U.S. patent application Ser. No. 11/740,794, entitled “System and Method for Processing Data Signals,” filed Apr. 26, 2007, which claims the benefit of U.S. patent application Ser. No. 60/796,396, filed May 1, 2006, the disclosures of which are incorporated herein by reference in their entirety. This application also claims priority to U.S. patent application Ser. No. 60/973,376, entitled “System and Method for Processing Data Signals,” filed Sep. 18, 2007, the disclosure of which is incorporated herein by reference in its entirety.

### BACKGROUND OF THE INVENTION

1. Field of the Invention

Embodiments of the present invention generally relate to a system and method for listeners, or “virtual fans,” to exist in a monitor mode during a real-time multimedia collaboration via a global computer network. More specifically, embodiments of the present invention relate to a system and method for a virtual fan in a monitor mode to incorporate audio input within a distributed mix with minimal or no latency.

2. Description of the Related Art

There has been a recent increase in musicians' interest to create a musical work without the need to assemble all musicians in one recording studio. One option is for musicians to collaborate via a global computer network to create a musical work. In the past, audio signals from different musicians, vocalists or other audio sources would be recorded individually at one location, transmitted to a central location, and later mixed together to form the musical work. The musical work could then be transmitted back to the musicians. However, this activity could not be performed in real-time or substantially real-time, and issues such as lack of interactivity and/or timing made the musical work difficult to mix, record, and produce.

Similar systems to form remote collaborative musical works required program servers to interface with a global computer network, and allow multiple musicians at different locations to send a MIDI audio stream to the server. The server would then mix the audio sources using a MIDI merge function and feed the merged MIDI signal back to participating musicians. This can also be done in a peer-to-peer manner, bypassing a network server and having each musician's computer mix the streams received from all other users. However, this system often could not provide live feedback to the musicians during their performance, and did not support the broad set of non-MIDI instruments and vocals.

Realizing these issues, certain systems and methods were developed to allow for near real-time music collaboration via a global computer network. For example, U.S. Pat. No. 6,898,637, issued May 24, 2005 to Curtin, discloses a method and apparatus that allows multiple musicians at various locations to collaborate on a musical work and provide near real-time feedback of the collaborative work to the musicians. The system disclosed in Curtin provides a server and a plurality of musicians/clients. An audio signal is generated by each of the clients and transmitted to the server, where the each of the signals are mixed together and transmitted back, as a collaborative work, to all of the musicians/clients. As a result, each of the musicians receive, and can listen to, an audio mix of all the individual audio signals in near real-time.

However, the system disclosed in Curtin creates a new set of issues for real-time data collaboration via a global computer network. For example, Curtin teaches that each musician receives the collaborated work comprising all of the individual audio signals, including the musician's own audio signal. As a result, a musician (e.g., an electric guitarist) is playing an instrument and likely hearing the instrument as it is being played. However, due to a time lag in the signal transmission, the musician is receiving the collaborative work moments later. Thus, an undesirable echoing effect likely occurs as the musician hears the signal from her/his own instrument moments after it was heard in the first instance. Additionally, each musician must listen to the same mix of all others, and cannot adjust the mix to suit individual preference or maximize creative composition.

Additionally, attempts have been made to place these mix compositions in a virtual venue for other people, such as fans of the musicians, to hear them. Generally, however, the mix compositions are pre-recorded and/or are streamed from a single location (e.g., a recording studio where all the musicians are collectively playing).

Thus, there is a need for an improved system and method for listeners, or virtual fans to exist in a monitor mode during a real-time multimedia collaboration via a global computer network.

### SUMMARY OF THE INVENTION

Embodiments of the present invention generally relate to a system and method for listeners, or “virtual fans,” to exist in a monitor mode during a real-time multimedia collaboration via a global computer network. In one embodiment, a system for processing data signals via a communication network comprises a first data signal received from a first client, a second data signal received from a second client, a mixer for mixing the first and second data signals, a first unique data mix, for the first client, generated by the mixer, a second unique data mix, for the second client, generated by the mixer, and a third unique data mix, for a fan room, generated by the mixer.

In another embodiment of the present invention, a method of processing data signals comprises generating a first data signal from a first client, generating a second data signal from a second client, receiving the first and second data signals at a mixer, creating first, second, and third unique mixes in the mixer, sending the first unique mix to the first client, sending the second unique mix to the second client, and sending the third unique mix to a fan room.

In yet another embodiment of the present invention, a computer readable medium comprising a computer program having executable code, the computer program for enabling real-time multimedia data mixing, the computer program comprising instructions for generating a first multimedia data signal from a first client, generating a second multimedia data signal from a second client, receiving the first and second multimedia data signals at a mixer, creating first, second, and third unique mixes in the mixer, sending the first unique mix to the first client, sending the second unique mix to the second client, and sending the third unique mix to a fan room.

### BRIEF DESCRIPTION OF THE DRAWINGS

So the manner in which the above recited features of the present invention can be understood in detail, a more particular description of embodiments of the present invention, briefly summarized above, may be had by reference to embodiments, several of which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a block diagram of a general computer system in accordance with one embodiment of the present invention;

FIG. 2 depicts a block diagram of a system in accordance with one embodiment of the present invention;

FIG. 3 depicts a system architecture of audio-related program modules in accordance with one embodiment of the present invention;

FIG. 4 depicts a system schematic in accordance with one embodiment of the present invention;

FIG. 5 depicts a system of a Primary Fan client in accordance with one embodiment of the present invention; and

FIG. 6 depicts a flow chart of a method of processing data signals in accordance with one embodiment of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

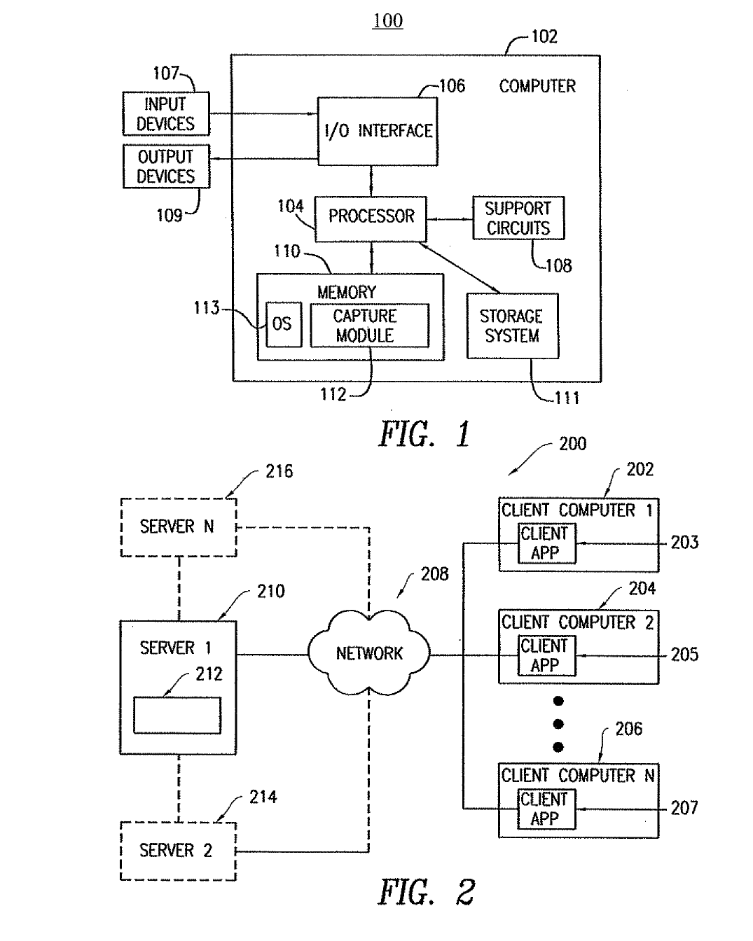

FIG. 1 depicts a block diagram of a general computer system in accordance with one embodiment of the present invention. The computer system 100 generally comprises a computer 102. The computer 102 illustratively comprises a processor 104, a memory 110, various support circuits 108, an I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. The storage system 111 may comprise any type of block-based storage device or devices, such as a disk drive system.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read only memory, magneto-resistive read/write memory, optical read/write memory, cache memory, magnetic read/write memory, and the like.

FIG. 2 depicts a block diagram of a system in accordance with one embodiment of the present invention. The system 200 generally comprises a first client computer 202, a second client computer 204, and additional client computers, up to client computer N 206, where N represents any number of client computers practical for operation of embodiments of the present invention. The system 200 further includes a network 208, a server 210, a mixer 212, and optionally a plurality of N additional servers (e.g., 214 & 216). The network 208 may be any network suitable for embodiments of the present invention, including, but not limited to, a global computer network, an internal network, local-area networks, wireless networks, and the like.

The first client computer 202 comprises a client application 203. The client application 203 is generally software or a similar computer-readable medium capable of at least enabling the first client computer 202 to connect to the proper network 208. In one embodiment, the client application 203 is software, commercially available by Lightspeed Audio Labs of Tinton Falls, N.J. In another embodiment, the client application 203 further provides instructions for various inputs (not shown), both analog and digital, and also provides instructions for various outputs (not shown), including a speaker monitor (not shown) or other output device. The second client computer 204 and client computer N 206 also comprise respective client applications (205, 207).

The server 210 may be any type of server, suitable for embodiments of the present invention. In one embodiment, the server 210 is a network-based server located at some remote destination (i.e., a remote server). In other embodiments, the server 210 may be hosted by one or more of the client computers. Additional embodiments of the present invention provide the server 210 is located at an internet service provider or other provider and is capable of handling the transmission of multiple clients at any given time.

The server 210 may also comprise a server application (not shown). The server application may comprise software or a similar computer-readable medium capable of at least allowing clients to connect to a proper network. In one embodiment, the server application is software, commercially available by Lightspeed Audio Labs of Tinton Falls, N.J. Optionally, the server application may comprise instructions for receiving data signals from a plurality of clients, compiling the data signals according to unique parameters, and the like.

The mixer 212 may be any mixing device capable of mixing, merging, or combining a plurality of data signals at any one instance. In one embodiment, the mixer is a generic computer, as depicted in FIG. 1. In another embodiment, the mixer 212 is capable of mixing a plurality of data signals, in accordance with a plurality of different mixing parameters, resulting in various unique mixes. The mixer 212 is generally located at the server 210 in accordance with some embodiments of the present invention. Alternative embodiments provide the mixer 212 located at a client computer, independent of server location.

As is understood by one of ordinary skill in the art, multiple servers may be the most efficient methods of communication between multiple clients when particular constraints exist. In one embodiment, multiple servers are provided to support multiple clients in a particular session. For example, in one embodiment, a group of three clients are connected through a first server 210 for a first session. A group of five clients want to engage in a second session, but the first server 210 is near capacity. The group of five clients are then connected through the second server 214 to allow for a session to take place.

For example, in another embodiment, a server 210 hosting a mixer 212 is provided in a system 200. As the server 210 becomes congested with multiple client transmissions, it may be beneficial to allow some of the clients to pass through a second server 214, thus relieving the bandwidth on the server 210. The second server 214 and first server 210 may be connected to one another through the network and/or any other known communication means to provide the most efficient methods of communication. If necessary, additional server N 216, where N represents any number of servers practical for operation of embodiments of the present invention, may be utilized as well.

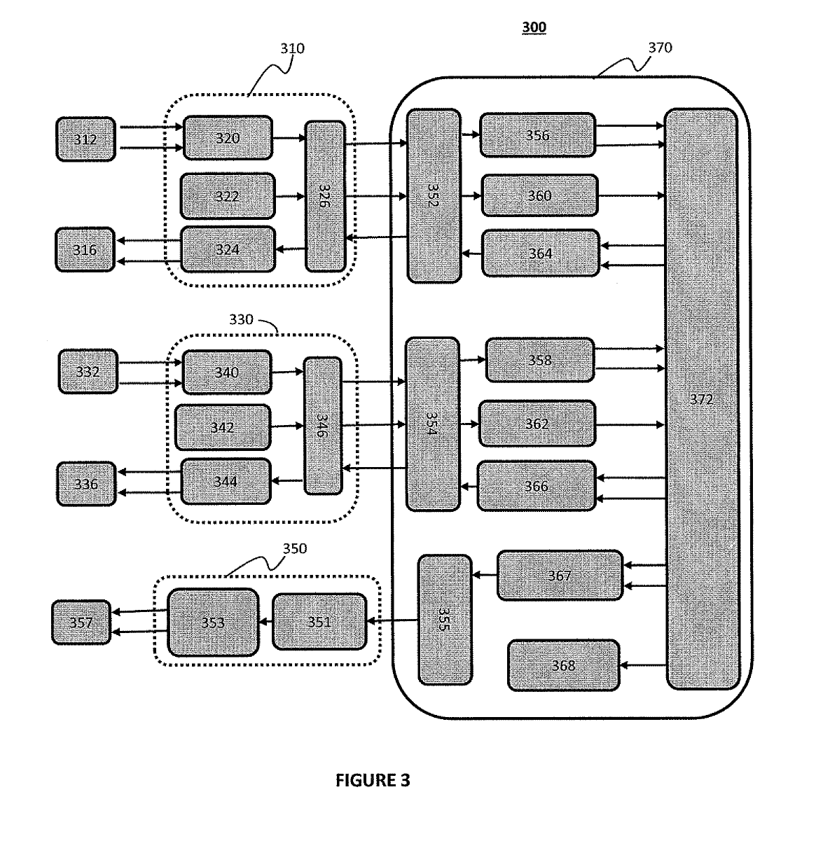

FIG. 3 depicts a block diagram of a system in accordance with one embodiment of the present invention. The system 300 generally comprises at least a first client 310, a second client 330, a fan room 350 and a server 370. Optionally, a plurality of additional clients (not shown), servers (not shown), or fan rooms (not shown) may be provided without deviating from the structure of embodiments of the present invention.

In accordance with one embodiment of the present invention, a first client 310 and a second client 330 are provided. Generally, the first client 310 and second client 330 may be any of or any combination of at least one of a basic computer, such as the one shown in FIG. 1, a personal computer, a portable computer, a handheld computer, a laptop computer, a mobile phone, or other known communication device. For simplicity, either of the first client 310 or the second client 330 may be generally referred to separately or collectively as “client” or “client PC.”

In one embodiment, the first client 310 comprises a first input 312 a first output 316 (collectively “audio I/O subsystem”, and an interface 326 for connecting to the server 370. The first client 310 may also comprise an audio encoder 320, and an audio decoder with error mitigation 324. Optionally, the first client 310 comprises a mix controller 322 having a graphical user interface (GUI).

The input device 312 comprises at least one of any musical instrument (e.g., guitar, drums, bass, microphones, and the like), other live or pre-recorded audio data (e.g., digital audio, compact disc, cassette, streaming radio, live concert, voice(s)/vocal(s), and the like), live or pre-recorded visual data, (e.g., webcam, pre-recorded video, and the like), other multimedia data, and the like. The output device 316 comprises at least one of headphones, speaker(s), video monitor, recording device (e.g., CD/DVD burner, digital sound recorder, and the like), means for feeding to other location, and the like.

The second client 330 similarly comprises an input device 332, an output device 336, an interface 346 for communicating with the server 370, an audio encoder 340, and an audio decoder with error mitigation 344. Optionally, the second client 330 comprises a mix controller 342 having a graphical user interface. The input device 332 and output device 336 are substantially similar to the first client input device 312 and output device 332, respectively.

The server 370 may be a computer at a central location, for example, one per urban area. The server 370 generally comprises a first interface 382 for communicating with the first client 310, a second interface 354 for communicating with the second client 330, a third interface 355 for communicating with a fan room 350, and a mixer 372. The server 370 may also comprise a first and second audio decoder with error mitigation 356, 358, a first and second controller for processing mix parameter instructions 360, 362, a first, second and third audio encoder 364, 366, 367, and a status console 368. The status console 368 provides a visual and/or audio indication of the status of the system 300, at any given time during operation.

The mixer 372 is provided to perform the mix of multiple client data signals into single, stereo, or multi-channel signals (e.g., 5.1 Channel Sound). For audio signals, a mix is generally understood as the addition or blending of wave forms. The mixer 370 generally comprises a plurality of input and output channels, equal to at least the number of clients communicating with the server 370 at any given time.

The fan room 350 may be any fan client, group of fan clients, virtual gathering of fan clients, or the like. The fan room 350 generally includes an audio decoder with error mitigation 353, an interface 351 for communicating with the server 370, and an output device 357, such as those discussed above. The fan room 350 may be in connection with the server 370, primarily receiving data from the server 370. Optionally, in other embodiments, the fan room 350 may permit data to be sent to and from clients in connection with server 370. In such an embodiment, applicable hardware and software, as understood by embodiments contained herein, would be required in the fan room 350.

Generally, the architecture of the system 300 generally supports multiple clients. In one embodiment, each client receives two monophonic audio signals, e.g., instrument and voice microphones. In such an embodiment, these signals are typically either an instrument or vocals. As such, each client may produce a stereo audio output signal, e.g., Left and Right Monitor Speakers, which is the stereo mix of a “jam session” containing all client voices and instruments. Alternatively, the mix could be 5.1 channels, allowing for a richer spatialization of a jam session.

As understood by embodiments of the present invention, the audio I/O subsystem in each PC has local, autonomous clocks. Typically, this would imply that a mechanism is needed to synchronize the each Client's input and output audio streams such that the Server mixer can process synchronized audio signals. However, in situations where the local clock asynchrony is 1000 ppm, (1/1000), then the client and/or server decoder output buffer queues will overflow or underflow every 1000 packets (i.e., 0.1% of the packets are lost due to the clock asynchrony (assuming one lost packet per overflow/underflow)).

Alternatively, another mechanism that may cause packet loss is jitter in the delivery latency with a global computer network connection (e.g., the Internet). This is generally caused by packets that arrive too late with respect to the real-time constraint imposed by the decoders in the server and client. Every Internet link has a distribution of arrival times, and the client/server system automatically adjusts itself so the decoder output queue depths are set, so the system experiences approximately 1% packet loss.

In another embodiment, one conclusion concerning the packet loss rate due to clock asynchrony (0.1%) and the loss rate due to IP jitter (1%) is that the latter dominates the former. In such a situation, there would be almost no reason to perform sample rate conversion in order to eliminate loss due to clock asynchrony. The system 300 would only need to have error mitigation strategies specifically designed to operate with a 1% packet loss rate.

In one embodiment, an audio codec is provided wherein the audio codec uses a block-processing algorithm. In this accord, the client input signal may be buffered for a duration of T_{B}, and then encoded and transmitted as a signal block. At the mixer 372, signal blocks are decoded and the resulting time frames are mixed and re-encoded for transmission to the various clients. In another embodiment, it may be desirable to have the framing of all client blocks synchronized to minimize differential latency due to framing asynchrony.

In another embodiment, at the clients, the input signals are received from an audio driver, for example, an audio input buffer, and are sent to the audio encoder 320, 340, where they are compressed for transmission to the server 370. In such an embodiment, the audio decoder 324, 344 receives the transmission from the server 370, decodes a compressed data mix, and sends it to an audio driver, such as an audio output buffer. In one embodiment, the compressed mix may include left and right output signals. In the case of channel packet errors, such as packets that arrive late, the decoder 324, 344 includes the capability for error mitigation. In one embodiment, all of these routines are coordinated via a higher-level routine that also manages the transmission of compressed audio and control data over the interface between the first or second clients 310, 330 and server 370.

In one embodiment, at the server 370, a routine may coordinate the transmission of compressed audio and control data over the communication interface between the first and second clients 310, 330 and server 370, and also coordinates audio-related routines. In such an embodiment, the decoders 356, 358 of the server 370 receive compressed audio from the first or second client 310, 330, reproduce the input signals 312, 332 and present them to the mixer 372. The server 370 may receive the mix control parameters from the first or second client 310, 330 and present them to the mixer 372. The encoders 364, 366, 367 of the server 370 receive the mixed stereo signal associated with a given first or second client 310, 330, compress it and present it to the respective communication interfaces for transmission to the first or second client 310, 330 or the fan room 350.

In one embodiment of the present invention, the primary audio-related function of the server 370 is to perform the mix of the several client signals into a single stereo or multichannel signal. Each client may receive a different mix based on several issues at the client location. For example, If a musician is using the voice microphone audio signal channel for vocals, or has an instrument that is either acoustic, such as a piano, or has local monitors, such as an electric guitar with monitor, then those signals may need to be attenuated in the mix presented to that client to not have two versions of the signal, such as a local version and a mix version, with equal loudness but with the mix version delayed relative to the local. On the other hand, in another embodiment, if the musician is using the voice microphone audio signal channel for commentary that is not in the final mix, and non-acoustic instruments without local monitors, then those instruments can be included in the client mix. In another embodiment, all of these issues can be under client control via the GUI.

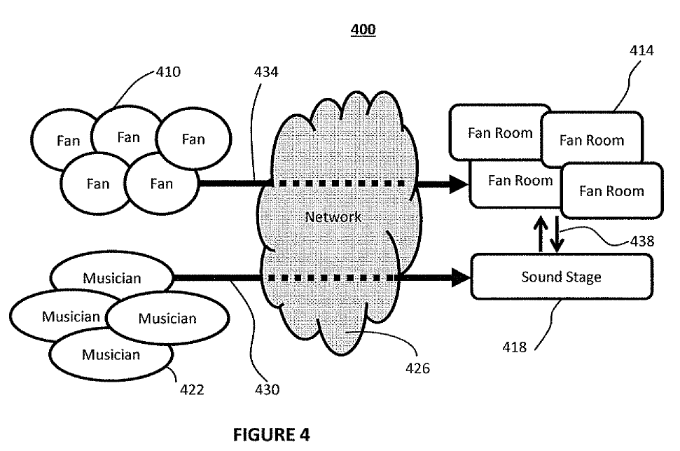

FIG. 4 depicts an embodiment of the system 400 for a virtual concert utilizing audio collaboration via a global computer network. Generally, the system 400 includes at least one fan 410 (hereinafter “fans”), at least one musician 422 (hereinafter “musicians”), a network 426, at least one fan room 414 and at least one sound stage 418. In one embodiment, the fans 410 are in communication with at least one fan room 414 via a network connection 434 that passes through the network 426. In this accord, the at least one musician 422 may be in communication with the sound stage 418 via a network connection 430 that passes through the network 426. Additionally, in another embodiment, the sound stage 418 may be situated to transmit and receive data signals 438 to and from the fan rooms 414.

In one embodiment, musicians 422 and fans 410 have connections via a broadband access and an IP network 426. Musicians 422 may meet and perform on a network sound stage 418, where real-time or near-real-time networking and signal processing enable an ongoing jam session or performance. In one embodiment, the collaboration is enabled by either peer-to-peer or client/server mixing wherein each musician 422 receives a unique mix of the other musicians input. A client or the central server creates one mix or a plurality of mixes for distribution, often referred to as a House Mix or House Mixes, respectively. In one embodiment, a House Mix may be the input to the Fan Room.

In one embodiment, a fan 410 may create a fan room 414, whereby a sound stage 418 is initiated. In such an embodiment, audio bit rates and quality may be reduced as the interactions between fans 410 will be predominately voice-based and not require as high an audio quality as the musicians 422. Optionally, the originator, whether the fan 410 or the musician 422, may invite friends to enter the sound stage 418, or open it for anyone to enter. Participants would then be able to listen to a selected distribution mix, talk, sing, or the like. Each participant may have full control of audio levels of other fans 410 and the distribution mix. However, the control would not extend to the levels of the individual musicians 422 contributing to the distribution mix.

In another embodiment, interaction between fan rooms 414 and musicians 422 on the sound stage 418 may be supported. In one embodiment, a method is provided to merge the fan room 414 and sound stage 418 into one larger collaboration venue, such as a larger sound stage 418. An optional method is to take the outputs of both the fan rooms 414 and sound stage 418, as single inputs to the other. Alternatively, in another embodiment, a mute function may be provided to the sound stage 418 to provide a level of control over distraction to the performers. In another embodiment, a separate group or subset of fans 410 may participate directly with the musicians 422. In this case, fans 410 would be no different than musicians 422 from a client-interaction standpoint.

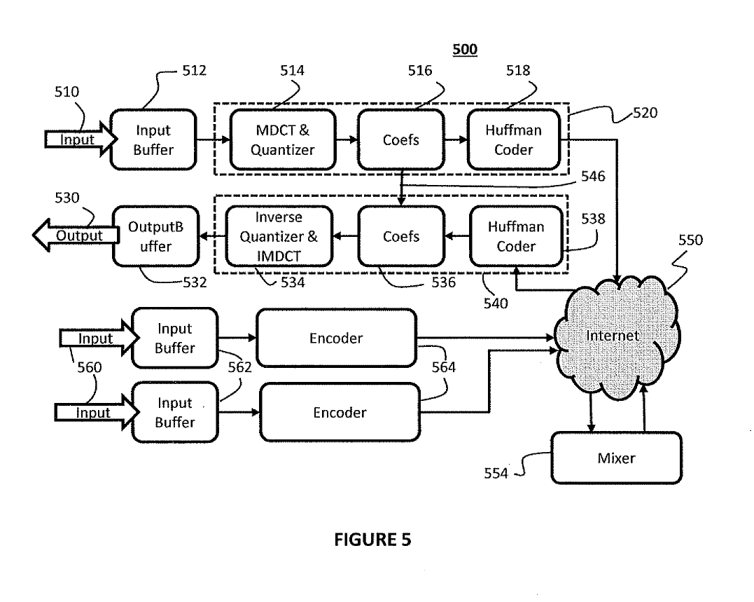

FIG. 5 depicts an architecture of a system 500 of Primary Fan clients in accordance with one embodiment of the present invention. The system 500 generally includes an input signal 510 transmitted initially into an input buffer 512. The input signal 510 may include any signal or quantity of transferrable data, or the like, and may generally be referred to as a “data packet.” In accordance with one embodiment, the input buffer 512 is situated to temporarily store the data packet 510. In another embodiment, the data packet 510 may be compressed in the input buffer 512. The data packet 510 may then be transmitted to an encoder 520. A decoder 540 is situated to be in communication with the encoder 520. In one embodiment, the encoder 520 and decoder 540 may be in communication through the internet as is shown in FIG. 5. In another embodiment, the encoder 520 and decoder 540 may be in communication via any other network, including a local area network, and the like. An output buffer 532 may be situated to receive the data packet 510 from the decoder 540 and output an output signal 530.

In accordance with one embodiment of the present invention, the encoder 520 generally includes a modified discrete cosine transform (hereinafter “MDCT”) and Quantizer 514, appropriate Coefficients 516, and a Huffman Coder 518. Similarly, in one embodiment, the decoder comprises a Huffman Decoder 538, appropriate Coefficients 536, and an Inverse Quantizer and inverse modified discrete cosine transform (hereinafter “IMDCT”) 534. In accordance with one embodiment, the encoder 520 and decoder 540 may be in monitor mode communication, as depicted by signal 546.

In monitor mode, Primary Fans have the ability to hear their own voice in the mix via a local mix path. Generally, this ability requires substantially cancelling their voice in the House Mix, and inserting their voice via a local path. In one embodiment, to accomplish this, the local voice signal is inserted at a point that is advanced in time relative to when it occurs in the received House Mix, thus giving the Primary Fan client low latency in hearing their voice. For example, when a Primary Fan client listening to the House Mix speaks, or creates an audio input, the audio input is heard by the client as if it was spoken at the same time within the House Mix.

In accordance with one embodiment of the present invention, the system 500 may include any number of input signals 560. In this accord, the additional input signals 560 may be transmitted to input buffers 564 and then to any additional number of encoders 564. The Encoders may be situated to communicate with other parts of the system 500 via the internet 550.

In one embodiment of the present invention, in operation, audio data is provided, such as a voice or a musical signal, via the audio input, such as a microphone, to the system 500 where it is encoded for transmission. In one embodiment, during the data encoding process, every two adjacent audio input buffers 512 may receive a sequence number. The sequence number may be assigned to a packet containing the coded representation of the two adjacent audio input buffers 512. The sequence number is associated with the two blocks as processed by the MDCT and Quantizer components 514. The data associated with the sequence number is further processed by the remaining encoder components, such as the Coefficients 516 and the Huffman coder 518, and formatted as a packet for transport. In such embodiments, the same sequence number may be associated with data received from the mixer 554 after the audio input is added to the House Mix.

In accordance with embodiments of the present invention, transmitted and received data packets with the same sequence number contain the identical segment of data, such as a voice signal, from the Primary Fan. However, the received data may be modified with respect to the transmitted data in at least two respects. First, the received data may be modified by gain and pan. Generally, the transmitted data will be processed by at least the House Mix parameters, such as gain and pan, at the server. Second, the received data may be modified by the quantization step in the audio encoding done by the audio server following the generation of the House Mix.

In one embodiment of the present invention, the Primary Fan client encodes packet N. Two monophonic coefficient buffers associated with packet N may be modified by PF_{gain} and PFₚₐₙ to create two stereophonic coefficient buffers. In such embodiments, the Primary Fan client saves the stereophonic coefficient buffers in a “First In First Out” (hereinafter “FIFO”) queue and affixes a label known as buffer set N. The buffer set N is added into the two stereo decoder coefficient buffers that will decode to the next output buffer to be sent to the audio output. When packet N is received from the Audio Server, it is decoded to the coefficient buffer and subtracted from that buffer coefficient buffer set N from the FIFO queue. This process eliminates the delayed version of the Primary Fan's transmitted data, for example, a transmitted voice signal, subject to errors associated with quantization in the encoding of the house mix at the server.

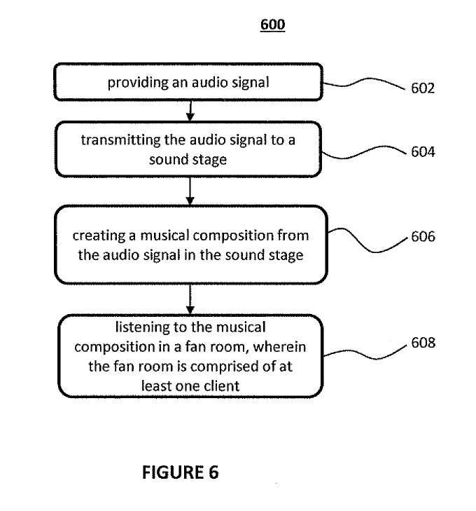

FIG. 6 depicts a flowchart of a method 600 of processing data signals in accordance with one embodiment of the present invention. The method 600 is understood by embodiments of the present invention to occur in “real-time”. Real-time is known in the industry as near-instantaneous, subject to minor delays caused by network transmission and computer processing functions, and able to support various input and output data streams. The method 600 may be utilized with respect to the system 300 disclosed in FIG. 3, the system 400 disclosed in FIG. 4, the system 500 disclosed in FIG. 5, or any other system. All descriptions of the processed occurring at any one client described herein are intended by embodiments of the present invention to be applicable to any or all additional clients.

The method 600 begins at step 602 as a plurality of data signals are generated from the input devices at the respective clients. In one embodiment, the data signals comprise a plurality of audible sounds from various musical instruments. Other embodiments provide the data signals may comprise any variation or sampling of multimedia data.

At step 604, the audio signal is transmitted to a virtual sound stage, hosted at a server. The data signals from the respective clients are transmitted to the mixer, located at the server, via standard communication methods. To accomplish this step, the data signal is first collected by the respective client, via the input device. Optionally, the data is passed through a sample rate converter, which accommodates and accounts for the asynchronous timing of each client's respective internal clocks.

From the sample rate converter, the data is passed through an audio encoder where it is compressed for efficient transmission to the server. In one embodiment, the encoding is performed using a block-processing algorithm, whereby the data is buffered at a predetermined duration, which is then capable of being transmitted as a packet or block.

The transmission from the clients to the server occurs through the respective interfaces. The interfaces may be capable of handling any known transmission protocols including TCP/IP and/or UDP. Other plausible transmission protocols include FTP, ATM, Frame relay, Ethernet, and the like. Once received at the server, the data is passed through an audio decoder with error mitigation, where the data is decompressed for mixing by the mixer. The error mitigation allows for correction or otherwise fixing, filling, or skipping any data packet errors, for example, late packets, otherwise unavailable packets, or any other transmission or data error that may occur.

If error mitigation is necessary, for example, due to packet loss, the audio decoder will implement an error concealment strategy. Error concealment strategies may include repetition of a previous packet, linear estimation of the missing packet (based on earlier packet and subsequent packet data), model-based estimation of the missing packet, inserting a zero packet (i.e., the effect of estimating the data as zero), and the like. In one embodiment, an error concealment strategy comprises performing a linear predictive estimation in the frequency domain of a missing data packet. By performing the linear predictive estimation in the frequency domain, an accurate approximation is generally obtained. A more detailed discussed of such types of strategies is found in co-owned United States Patent Application Publication No. 2007/0255816, the disclosure of which is incorporated herein by reference in its entirety.

At step 606, the data signal is sent from the client to the sound stage where it is mixed with data signals sent from other clients, to create a unique mix or plurality of unique mixes at the mixer. A unique mix is a mix created for an individual client, based on specific mixing instructions from the client. Embodiments of the present invention provide that if a number of clients N are connected to a server in any given session, at least N number of unique mixes may be created during that session.

The mixing instructions to create a unique mix for a client may be set by the client. In one embodiment, the mix controller having a graphical user interface provides the client the ability to manipulate the unique mix for the client. The mix controller communicates with the mixer via the respective interfaces and the controller for processing mix parameter instructions.

The mix controller may control the gain/level, balance/pan, equalization, reverb, tone, and/or dynamics of each individual data signal sent to the mixer. In several embodiments of the present invention, the mix controller may control any aspect of an individual multimedia signal that may be processed through a standard channel strip. For example, in one embodiment, there may be a guitarist, vocalist, drummer, and bassist sending data signals to the mixer in a session, all from different client locations. The guitarist may want to only hear the drummer and bassist, and may manipulate the data signals entering her/his unique mix by altering the gain levels on the mix controller. Similarly, the drummer may want all data signals present, but have the bass only on a right-channel output, and have the vocals louder than the guitar. The drummer could manipulate the data signals accordingly, and receive her/his unique mix. By providing every client with a mix controller, each client may receive a unique mix desirable to that client.

Similarly, a unique mix may be created for the fan room. In one embodiment, thi unique mix may comprise each of the input audio signals from each of the clients. In another embodiment, the unique mix for the fan room may be similarly controlled by a lead “fan” or organizer of the fan room.

In one embodiment of the present invention, the unique mix of every client is defaulted to exclude the clients' own data signal. By excluding the clients' own data signal, the individual at the client will avoid hearing an echo of the individuals own voice. While embodiments of the present invention provide a real-time method and system of processing such data, slight delay may be noticeable to the client, even if the delay is on the order of 10 ms or less, in some cases. Thus, an individual, e.g., a vocalist, who can hear her/his own voice while singing or speaking, will not want to hear her/his voice in the respective unique mix.

However, if the client desires to receive his/her own generated data signal in the unique mix, the data signal may be re-inserted at the client, just prior to the output device. For example, if an individual at the client is playing an electronic keyboard, the individual may not be able to hear the output from the keyboard itself as the individual is playing. In such a situation, it would be desirable to place the client's data signal in the unique mix received by that client. In one embodiment, the client's own data signal is re-inserted in the unique mix at the client, such that the time delay between generating the data signal and producing the signal at the output is minimal.

At step 608, a unique mix, or musical composition, is transmitted to a fan room. In accordance with one embodiment of the present invention, the fan room is comprised of a plurality of fan clients. As understood by embodiments of the present invention, the fan room may be as small or large as necessary to accommodate an unlimited number of users within the system.

While the foregoing is directed to embodiments of the present invention, other and further embodiments of the invention may be devised without departing from the basic scope thereof.

What is claimed is:

1. A system for processing data signals via a communication network comprising:
a first data signal received from a first client;
a second data signal received from a second client;
a mixer for mixing the first and second data signals;
a first unique data mix, for the first client, generated by the mixer;
a second unique data mix, for the second client, generated by the mixer; and
a third unique data mix, for a fan room, generated by the mixer.

2. The system of claim 1, wherein the first unique data mix is exclusive of the first data signal; wherein the second unique data mix is exclusive of the second data signal; and wherein the third unique data mix comprises both the first and second data signals.

3. The system of claim 1, wherein the mixer is located at a remote-server location.

4. The system of claim 1, further comprising:
a recorder for recording the first data signal and second data signal.

5. The system of claim 1, wherein the fan room comprises a plurality of clients.

6. The system of claim 5, wherein the fan room is hosted by one of the plurality of clients.

7. The system of claim 1, wherein the first data signal and second data signal comprise multimedia data.

8. The system of claim 7, wherein the multimedia data comprises at least one of audio data or video data.

9. A method of processing data signals comprising:
generating a first data signal from a first client;
generating a second data signal from a second client;
receiving the first and second data signals at a mixer;
creating first, second, and third unique mixes in the mixer;
sending the first unique mix to the first client;
sending the second unique mix to the second client; and
sending the third unique mix to a fan room.

10. The method of claim 9, wherein the first unique mix is exclusive of the first data signal; wherein the second unique mix is exclusive of the second data signal; and wherein the third unique data mix comprises both the first and second data signals.

11. The method of claim 9, wherein the first data signal and second data signal comprise multimedia data.

12. The method of claim 11, wherein the multimedia data comprises at least audio data or video data.

13. The method of claim 9, wherein the fan room comprises at least a first fan and a second fan.

14. The method of claim 13, further comprising:
generating a third data signal at the first fan; and
receiving the third data signal at the second fan.

15. The method of claim 9, further comprising:
generating an additional data signal in the fan room;
receiving the additional data signal at the mixer; and
adding the third data signal to the first and second unique mixes.

16. A computer readable medium comprising a computer program having executable code, the computer program for enabling real-time multimedia data mixing, the computer program comprising instructions for:
generating a first multimedia data signal from a first client;
generating a second multimedia data signal from a second client;
receiving the first and second multimedia data signals at a mixer;
creating first, second, and third unique mixes in the mixer;
sending the first unique mix to the first client;
sending the second unique mix to the second client; and
sending the third unique mix to a fan room.

17. The computer readable medium of claim 16, wherein the first unique mix is exclusive of the first data signal; wherein the second unique mix is exclusive of the second data signal; and wherein the third unique data mix comprises both the first and second data signals.

18. The computer readable medium of claim 16, wherein the multimedia data comprises at least audio data or video data.

19. The computer readable medium of claim 16, the computer program further comprising instructions for:
generating a third data signal at a first fan in the fan room; and
receiving the third data signal at a second fan in the fan room.

20. The computer readable medium of claim 16, the computer program further comprising instructions for:
generating an additional data signal in the fan room;
receiving the additional data signal at the mixer; and
adding the third data signal to the first and second unique mixes.
